(19) United States
(12) Patent Application Publication
(10) Pub. No.: US 2020/0076110 A1
(43) Pub. Date: Mar. 5, 2020

(54) CONNECTOR-ASSEMBLY WITH PRIMARY-LOCK-REINFORCEMENT DEVICE

(71) Applicant: Delphi Technologies, LLC, Troy, MI (US)

(72) Inventors: Darien Aguilar Baza, Saltillo (MX); Francisco J. Hernandez Camarillo, Saltillo (MX)

(21) Appl. No.: 16/115,005

(22) Filed: Aug. 28, 2018

(51) Int. Cl. H01R 13/436; H01R 13/424

(52) U.S. Cl. CPC H01R 13/4365; H01R 13/424

(57) ABSTRACT

A connector-assembly includes electrical-terminals, a connector-housing, and a primary-lock-reinforcement device. The electrical-terminals are configured to mate with corresponding electrical-terminals along a mating-axis of the connector-assembly. The connector-housing is configured to retain the electrical-terminals within terminal-cavities defined by a terminal-tower disposed within the connector-housing. The primary-lock-reinforcement device is configured to slideably engage the terminal-tower and is moveable from a pre-stage position to a full-stage position. The primary-lock-reinforcement device has a base and a skirt defining a cavity having a flexible-beam disposed within and terminating at a tip. The tip engages a stop in the connector-housing in the pre-stage position inhibiting a movement of the primary-lock-reinforcement device along the mating-axis. When the electrical-terminals are fully seated into the terminal-cavities, the electrical-terminals disengage the tip from the stop enabling the primary-lock-reinforcement device to move from the pre-stage position to the full-stage position.

### TECHNICAL FIELD OF INVENTION

This disclosure generally relates to an electrical connector-assembly, and more particularly relates to an electrical connector-assembly with a primary-lock-reinforcement device.

### BRIEF DESCRIPTION OF DRAWINGS

The present invention will now be described, by way of example with reference to the accompanying drawings, in which:

FIG. 1 is an exploded perspective view illustrating a connector-assembly in accordance with one embodiment;

FIG. 2 is a perspective end-view of a primary-lock-reinforcement device isolated from the assembly of FIG. 1 in accordance with one embodiment;

FIG. 3A is a terminal-end view of the connector-assembly of FIG. 1 in accordance with one embodiment;

FIG. 3B is a top section view of the connector-assembly of FIG. 3A in accordance with one embodiment;

FIG. 4A is a section view of a portion of the connector-assembly of FIG. 1 with an electrical-terminal fully seated and the primary-lock-reinforcement device in a full-stage position in accordance with one embodiment; and

FIG. 4B is a section view of the connector-assembly of FIG. 1 with the primary-lock-reinforcement device in the full-stage position in accordance with one embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

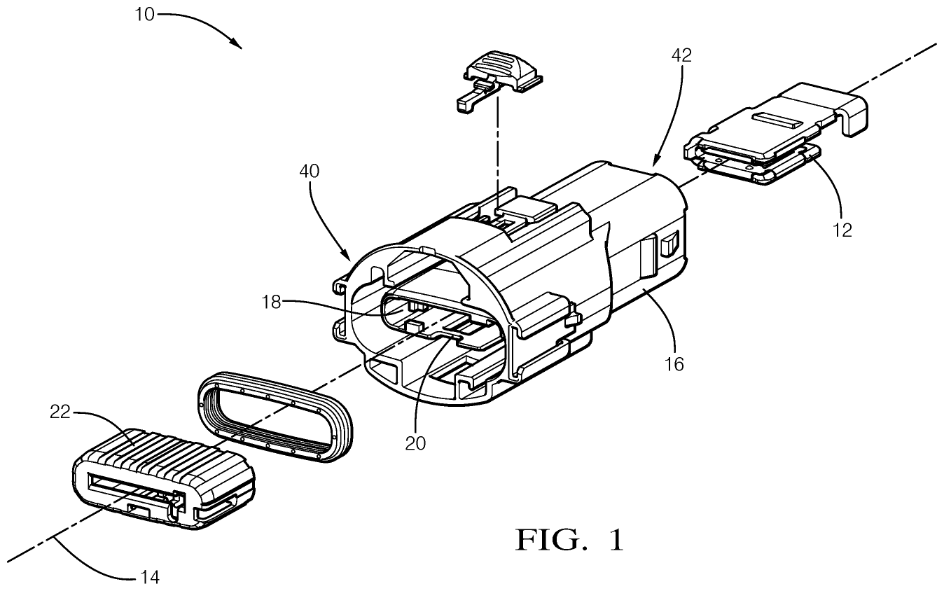

FIG. 1 is an exploded view illustrating a connector-assembly 10. As will be described in more detail below, the connector-assembly 10 is an improvement over prior art connector assemblies, because the connector-assembly 10 maintains a position of its components during shipping and handling and inhibits inadvertent and/or premature movement. The connector-assembly 10 includes one or more electrical-terminals, hereinafter referred to as the terminals 12, configured to mate with one or more corresponding electrical-terminals (not shown) along a mating-axis 14 of the connector-assembly 10. The terminals 12 are formed of an electrically conductive material, such as a copper-based alloy that may also include a coating of another conductive material (e.g. a tin-based or silver-based coating). The terminals 12 are configured to be attached to wire cables (not shown) that may be a component of a wiring-harness of a vehicle.

The connector-assembly 10 also includes a connector-housing 16 configured to retain the terminals 12 within one or more terminal-cavities, hereinafter referred to as the cavities 18, defined by a terminal-tower 20 disposed within the connector-housing 16. The connector-housing 16 is formed of a polymeric dielectric material. The polymeric dielectric material may be any polymeric dielectric material capable of electrically isolating portions of the terminals 12, and is preferably a polyamide (NYLON) material.

The connector-assembly 10 also includes a primary-lock-reinforcement device 22 (PLR-device 22) configured to slideably engage the terminal-tower 20. The PLR-device 22 is preferably formed of the same polymeric dielectric material as the connector housing 16, but may be any polymeric dielectric material. The PLR-device 22 is moveable from a pre-stage position 24 to a full-stage position 26, as will be explained in more detail below.

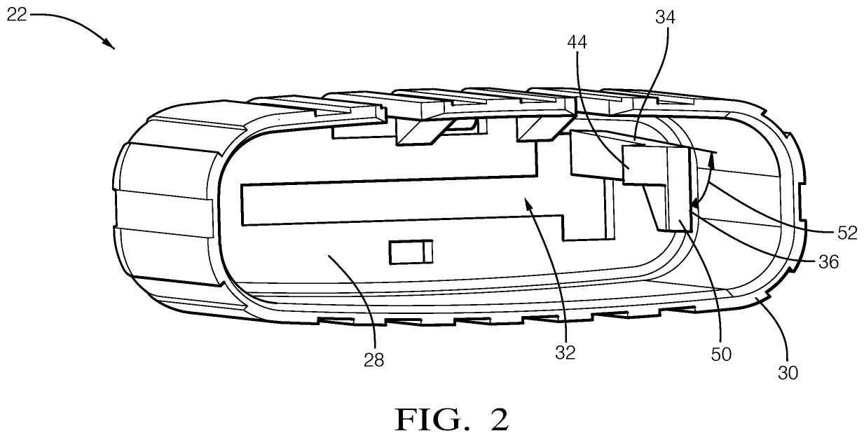

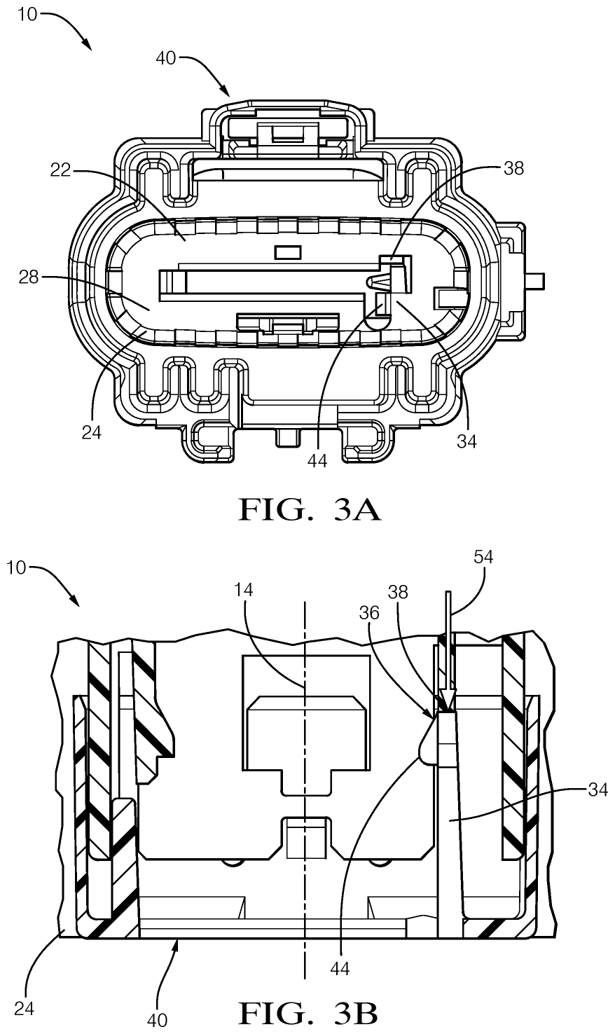

FIG. 2 illustrates the PLR-device 22 isolated from the connector-assembly 10 of FIG. 1. The PLR-device 22 has a base 28 and a skirt 30 defining a cavity 32. A flexible-beam 34 is disposed within the cavity 32 extending from the base 28 parallel to the mating-axis 14 and terminating at a tip 36. The base 28 also defines one or more apertures (not specifically shown) through which the corresponding electrical-terminals pass when mating with the terminals 12. In the example illustrated in FIG. 2, the flexible-beam 34 is formed integral to the base 28. The tip 36 is configured to engage a stop 38 (see FIGS. 3A-3B) formed in the connector-housing 16 when the PLR-device 22 is in the pre-stage position 24, thereby inhibiting a movement of the PLR-device 22 along the mating-axis 14. In the example illustrated in FIG. 2 the stop 38 is disposed within the cavities 18. In another embodiment, the stop 38 is located on the terminal-tower 20 external to the cavities 18.

FIG. 3A is a terminal-end 40 view of the connector-assembly 10 of FIG. 1 with the PLR-device 22 in the pre-stage position 24, and illustrates the stop 38 within the connector-housing 16. FIG. 3B is a top section view of a portion of the connector-assembly 10 of FIG. 3A illustrating the interaction between the tip 36 of the flexible-beam 34 and the stop 38, with the PLR-device 22 in the pre-stage position 24. The pre-stage position 24 enables an assembler to insert the terminals 12 into the connector-housing 16 through a wire-end 42 of the connector-housing 16 (see FIG. 1) to be seated within the cavities 18. It will be appreciated that if the PLR-device 22 is inadvertently moved to the full-stage position 26, as can result during shipping and handling, the assembler will be inhibited from fully inserting the terminals 12 into the connector-housing 16.

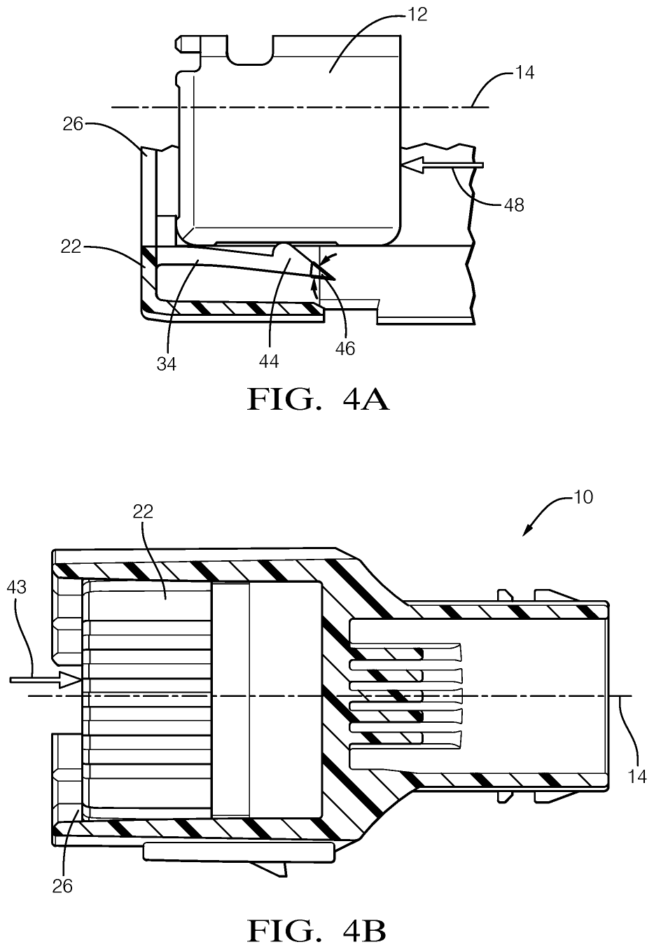

FIGS. 4A-4B illustrate the PLR-device 22 in the full-stage position 26. When the terminals 12 are inserted into the cavities 18, the terminals 12 deflect the flexible-beam 34 disengaging the tip 36 from the stop 38, thereby enabling the PLR-device 22 to move from the pre-stage position 24 to the full-stage position 26 when the terminals 12 are fully seated in the cavities 18. The terminals 12 must be fully seated before the PLR-device 22 may be moved to the full-stage position 26 due to one or more terminal-locks (not specifically shown) that also inhibit the movement of the PLR-device 22 until the terminal-locks are latched in corresponding terminal-notches (not specifically shown) of the terminals 12. For ergonomic reasons, a force 43 of less than 45-Newtons is required to move the PLR-device 22 from the pre-stage position 24 to the full-stage position 26 when the terminals 12 is fully seated in the cavities 18.

Referring back to FIG. 4A, the tip 36 of the flexible-beam 34 includes an unlocking-ramp 44 configured to engage a leading-edge of the terminals 12 as the terminals 12 are inserted into the cavities 18. The unlocking-ramp 44 extends into the cavities 18 in a direction generally orthogonal to the mating-axis 14 as illustrated in FIGS. 3A-3B. The unlocking-ramp 44 is characterized as having the engagement-angle 46 relative to the mating-axis 14 of between 20-degrees and 80-degrees so that an insertion-force 48 applied to the terminals 12 of less than 30-Newtons is required to deflect the flexible-beam 34. A cross-sectional area and a length of the flexible-beam 34 may be adjusted along with the engagement-angle 46 to meet the insertion-force 48 target.

Referring back to FIG. 2, the tip 36 of the flexible-beam 34 includes a blocking-fin 50 configured to engage the stop 38. The blocking-fin 50 extends from the tip 36 in a direction generally orthogonal to the mating-axis 14 and generally orthogonal to the unlocking-ramp 44. The blocking-fin 50 is characterized as having a blocking-angle 52 relative to the mating-axis 14 of about 90-degrees. The blocking-fin 50 engages the stop 38 such that a blocking-force 54 (see FIG. 3B) greater than 80-Newtons is required to move the PLR-device 22 from the pre-stage position 24 to the full-stage position 26 when the terminals 12 are not fully seated in the cavities 18. The blocking-force 54 of greater than 80-Newtons is advantageous because the blocking-force 54 is sufficiently greater than the force 43 required to move the PLR-device 22 from the pre-stage position 24 to the full-stage position 26 (when the terminals 12 are fully seated in the cavities 18). The blocking-force 54 may alert an assembler to an un-seated condition and take actions to correct the issue before further process steps are conducted.

Accordingly, a connector-assembly 10 is provided. The connector-assembly 10 is an improvement over prior art connector-assemblies because the connector-assembly 10 includes the PLR-device 22 that resists movement from the pre-stage position 24 to the full-stage position 26 until the terminals 12 are fully seated in the cavities 18, thereby providing the benefit of alerting an assembler to an un-seated terminal condition.

While this invention has been described in terms of the preferred embodiments thereof, it is not intended to be so limited, but rather only to the extent set forth in the claims that follow. “One or more” includes a function being performed by one element, a function being performed by more than one element, e.g., in a distributed fashion, several functions being performed by one element, several functions being performed by several elements, or any combination of the above. It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact. The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Directional terms such as top, bottom, upper, lower, left, right, front, rear, etc. do not denote any particular orientation, but rather these directional terms are used to distinguish one element from another and establish a relationship between the various elements.

1. A connector-assembly, comprising:
an electrical-terminal configured to mate with a corresponding electrical-terminal along a mating-axis of the connector-assembly;
a connector-housing configured to retain the electrical-terminal within a terminal-cavity defined by a terminal-tower integrally formed by the connector-housing; and
a primary-lock-reinforcement device separate from the connector-housing and configured to slideably engage the terminal-tower, wherein the primary-lock-reinforcement device is moveable from a pre-stage position to a full-stage position, wherein the primary-lock-reinforcement device has a base and a skirt defining a cavity, wherein the primary-lock-reinforcement device has a flexible-beam disposed within the cavity that extends from the base parallel to the mating-axis and terminates at a tip, wherein the tip is positioned to engage a stop formed in the connector-housing when the primary-lock-reinforcement device is in the pre-stage position and the electrical-terminal is not inserted within the terminal-cavity, thereby inhibiting a movement of the primary-lock-reinforcement device along the mating-axis, wherein the flexible-beam is configured to be deflected in a direction away from the mating-axis when the terminals are electrical-terminal is inserted into the terminal-cavity, thereby disengaging the tip from the stop and enabling the primary-lock-reinforcement device to move from the pre-stage position to the full-stage position.

2. The connector-assembly in accordance with claim 1, wherein a force of less than 45-Newtons is required to move the primary-lock-reinforcement device from the pre-stage position to the full-stage position after the electrical-terminal is inserted into the terminal-cavity.

3. The connector-assembly in accordance with claim 1, wherein the tip of the flexible-beam includes an unlocking-ramp configured to engage a leading-edge of the electrical-terminal, the unlocking-ramp extending into the terminal-cavity in a direction generally orthogonal to the mating-axis.

4. The connector-assembly in accordance with claim 3, wherein the unlocking-ramp is characterized as having an engagement-angle relative to the mating-axis of between 20-degrees and 80-degrees.

5. The connector-assembly in accordance with claim 4, wherein an insertion-force applied to the electrical-terminal of less than 30-Newtons is required to deflect the flexible-beam.

6. The connector-assembly in accordance with claim 1, wherein the tip of the flexible-beam includes a blocking-fin configured to engage the stop and wherein the blocking-fin extends from the tip in a direction orthogonal to the mating-axis.

7. The connector-assembly in accordance with claim 6, wherein the blocking-fin is characterized as having a blocking-angle relative to the mating-axis of about 90-degrees.

8. The connector-assembly in accordance with claim 6, wherein a blocking-force greater than 80-Newtons is required to move the primary-lock-reinforcement device from the pre-stage position to the full-stage position when the electrical-terminal is not fully seated in the one or more terminal-cavities terminal-cavity.

9. The connector-assembly in accordance with claim 1, wherein the stop is disposed within the terminal-cavity.

10. The connector-assembly in accordance with claim 1, wherein the stop is located on the terminal-tower external to the terminal-cavity.

11. A primary-lock-reinforcement device, the primary-lock-reinforcement device moveable from a pre-stage position to a full-stage position, the primary-lock-reinforcement device configured to slideably engage a terminal-tower disposed within a connector-housing of a connector-assembly configured to retain an electrical-terminal within a terminal-cavity defined by the terminal-tower, the electrical-terminal configured to mate with a corresponding electrical-terminal along a mating-axis of the connector-assembly, the primary-lock-reinforcement device comprising:
a base and a skirt defining a cavity; and
a flexible-beam disposed within the cavity that extends from the base parallel to the mating-axis and terminates at a tip, wherein the tip is positioned to engage a stop formed in the connector-housing when the primary-lock-reinforcement device is in the pre-stage position and the electrical-terminal is not inserted within the terminal-cavity, thereby inhibiting a movement of the primary-lock-reinforcement device along the mating-axis from the pre-stage position to the full-stage position, wherein the flexible-beam is configured to be deflected in a direction away from the mating-axis when the electrical-terminal is inserted into the terminal-cavity, thereby disengaging the tip from the stop and enabling the primary-lock-reinforcement device to move from the pre-stage position to the full-stage position.

12. The primary-lock-reinforcement device in accordance with claim 11, wherein a force of less than 45-Newtons is required to move the primary-lock-reinforcement device from the pre-stage position to the full-stage position after the electrical-terminal is inserted into the terminal-cavity.

13. The primary-lock-reinforcement device in accordance with claim 11, wherein the tip of the flexible-beam includes an unlocking-ramp configured to engage a leading-edge of the electrical-terminal, the unlocking-ramp extending into the terminal-cavity in a direction generally orthogonal to the mating-axis.

14. The primary-lock-reinforcement device in accordance with claim 13, wherein the unlocking-ramp is characterized as having an engagement-angle relative to the mating-axis of between 20-degrees and 80-degrees.

15. The primary-lock-reinforcement device in accordance with claim 14, wherein an insertion-force of less than 30-Newtons applied to the electrical-terminal is required to deflect the flexible-beam.

16. The primary-lock-reinforcement device in accordance with claim 11, wherein the tip of the flexible-beam includes a blocking-fin configured to engage the stop and wherein the blocking-fin extends from the tip in a direction orthogonal to the mating-axis.

17. The primary-lock-reinforcement device in accordance with claim 16, wherein the blocking-fin is characterized as having a blocking-angle relative to the mating-axis of about 90-degrees.

18. The primary-lock-reinforcement device in accordance with claim 16, wherein a blocking-force greater than 80-Newtons is required to move the primary-lock-reinforcement device from the pre-stage position to the full-stage position when the electrical-terminal is not fully seated in the terminal-cavity.
